(19) United States
(12) Patent Application Publication
(10) Pub. No.: US 2015/0112888 A1
(43) Pub. Date: Apr. 23, 2015

(54) VIDEO REVIEW AND RANKING PROCESS USING MEDIA FILES

(71) Applicant: Zvi Klepar, New York, NY (US)

(72) Inventor: Zvi Klepar, New York, NY (US)

(21) Appl. No.: 14/515,482

(22) Filed: Oct. 15, 2014

Related U.S. Application Data
(60) Provisional application No. 61/891,379, filed on Oct. 15, 2013.

(51) Int. Cl. G06Q 30/02

(52) U.S. Cl. CPC G06Q 30/0282
USPC 705/347

(57) ABSTRACT

The present invention manages video reviews and rankings, from a consumer utilizing company electronic media files delivered online by: verifying that the consumer is a customer of the company; if the consumer is verified, company obtains video review and ranking; company determines whether or not to offer a charitable donation in return for the video review and ranking; and if charitable donation has been made, notifying the verified consumer of the donation.

### CROSS REFERENCE TO RELATED APPLICATION

The present Application is related to Provisional Patent Application entitled “Video Review and Ranking Process Using Media Files,” filed 15 Oct. 2013 and assigned filing No. 61/891,379, incorporated herein by reference in its entirety.

### FIELD OF THE INVENTION

This invention pertains generally to Internet-based commerce and, more particularly, to a method and system for managing a ‘video review and ranking’ to a company providing video products from a consumer utilizing electronic media files delivered online via a link, a widget and/or QR code either embedded in the widget or a QR code shown separately that links to a company URL on the review server.

### BACKGROUND OF THE INVENTION

In the current state of the art, consumer reviews and rankings are written, which can be falsified by writers hired in the same or a different country. The identity and location of the review writer is not confirmed, and can be fictitious.

A video company can be engaged in unethical practices to acquire great reviews and achieve high rankings by hiring individuals to “make up” identities, write reviews, and produce rankings for the video company from essentially anywhere in the world.

Honest companies can be harmed, both when the company is playing by the rules and falls victim to consumers who give undeserved bad reviews, or from competitors who take steps to damage the honest company's reputation and improve their own competitive position in the marketplace by giving the honest company falsified bad reviews.

Video reviews can be generated using a variety of platforms. When video content is managed by the consumer, the review process creates technical problems due to the various ways available to manage large video files that are necessary for quality video review content. The use of such large video files can present difficulty in the posting of video reviews on the company's website.

Reviews are a dialog between a reviewer and a video company, not a simple video review. Current platforms may host the video content, but don't support a dialog between the reviewer and the video company.

### BRIEF SUMMARY OF THE INVENTION

In one aspect of the present invention, a method of managing video reviews and rankings, from a consumer utilizing company electronic media files delivered online comprises: verifying that the consumer is a customer of the company; if the consumer is verified, company obtains video review and ranking; company determines whether or not to offer a charitable donation in return for the video review and ranking; and if charitable donation has been made, notifying the verified consumer of the donation.

### BRIEF DESCRIPTION OF THE DRAWINGS

FIG. 1 is a two-page flowchart illustrating a process of a system functioning for companies who want a video review and ranking from consumers, in accordance with the present invention;

FIG. 2 is a flowchart illustrating a process option in which a company can offer a reward to a consumer for giving the company a video review and performance ranking through a charitable donation for providing a video review, within the process illustrated in FIG. 1;

FIG. 3 is a flowchart illustrating a process in which a company can manage video reviews they have received from their consumers. Video reviews that are accurate and beneficial to the company can be posted, while inaccurate or negative video reviews that can damage the company's reputation can be made private and released at the company's discretion, in accordance with the present invention;

FIG. 4 is a flowchart illustrating the measurements of the company and review handling of the company by the invention. Measurements are designed to ensure that video reviews are legitimate for both the consumer and the company. Company measurements are designed to make sure the company is honest in its management of reviews, and that consumers can see the measurements shown about the company to have confidence that the reviews are accurate.

### DETAILED DESCRIPTION OF THE INVENTION

The present invention, herein referred to as “Facereview,” enables a video company to subscribe to a video review and performance ranking (e.g., star ranking) service.

Facereview provides the company with a widget that includes an embedded QR code, which the company can place on their website or send to consumers by email, SMS (text message) or IM (Instant Message). Consumers can use the widget QR code to link to the Facereview video and ranking tools.

Facereview provides the video company with a QR code that they can place on their printed materials or website, which a consumer can scan to link to the Facereview video and ranking tools. Consumers can scan the QR code with their mobile device or email the QR code, copy it and open it on their mobile device to access the Facereview tool on the review application server.

In an exemplary embodiment, the Facereview system may enable the user to scan the QR code by which the imaging or camera function of the mobile communication device is activated. With the imaging or camera function thus activated, the user may then choose to record a video directly to the Internet or Cloud, for subsequent use as disclosed herein.

Facereview video and ranking tools support easy upload of consumer review videos, star ranking and ranking statistics of the company's performance. Facereview video and ranking tools support fair reviews and grading and at the same time allow companies to have dialog to interact with reviewers and manage their reviews in a way that gives them some control on part of the process while still ensuring the consumer voice is not ignored by the company.

Facereview platform technology provides companies and consumers the tools for the whole process of linking, widgets, QR codes, review application servers, video review upload, star ranking and statistical ratings, Facereview application management and a process for handling spam and negative reviews.

Facereview prevents fictitious reviews through geolocation of both the consumer making the video review and the company. When the consumer is using a mobile device their location is captured in the system and then matched with the location of the business. This process is also effective for local company services and adds another layer to prevent fictitious content from uploading to the Faceview system.

Facereview provides tools to the company that allows them to offer an incentive to the consumer for providing a video review in the form of a charitable donation. The company may select the amount of charitable donation they are willing to make for each review, cap the total monetary amount of charitable donations or limit the number of reviews where the company will pay a charitable donation. The consumer can then elect to have the company pay a charitable contribution when they provide a video review and ranking.

Facereview provides the company with tools to allow dialog with the consumer to advise the consumer that a charitable donation has been made in their name through email, SMS (text message) or IM (Instant Messaging).

Facereview provides the company with tools in the administrative portion of the application to see the charitable donations they need to make and record the date and amount of the charitable donations they do make.

Facereview provides the company with tools to manage video reviews that are recognized as not being legitimate, such as spam reviews, by requesting proof that a reviewer is actually a customer of the company. If a reviewer can not provide proof that he or she is a customer, or refuses to provide the proof, the company can report the particular reviewer's video review as spam. This action enables the company to prevent the video spam review from being posted and adversely affecting the star ranking results.

Facereview provides the company with tools to manage negative reviews through a dialog with the consumer, and then allows the consumer to remove the negative review, to revise the review, or to leave the review as it was originally uploaded.

Facereview provides the consumer with tools that may be used if the company tries to claim that a consumer's negative review is not a legitimate review and is a spam review. In response to the claim, the consumer can submit a TANR (Trying to Avoid Negative Review) report, which initiates an audit of the video review requesting a determination be made (i) that the video review is either a legitimate review, or (ii) that the video review is indeed spam.

Facereview provides the company with tools to manage negative reviews when the consumer will not revise or remove the illegitimate review. The star ranking will still impact the overall company rating and the review statistics, however, the illegitimate video review(s) can be made private.

Facereview further provides the company with tools to manage private video reviews when potential customers ask to see private reviews. In response, the company can allow the potential customer to see the private reviews, or may refuse access. Alternately, the company can allow the potential customer to view the company response to the negative review, and also allow the potential customer to view the related video that received the negative review.

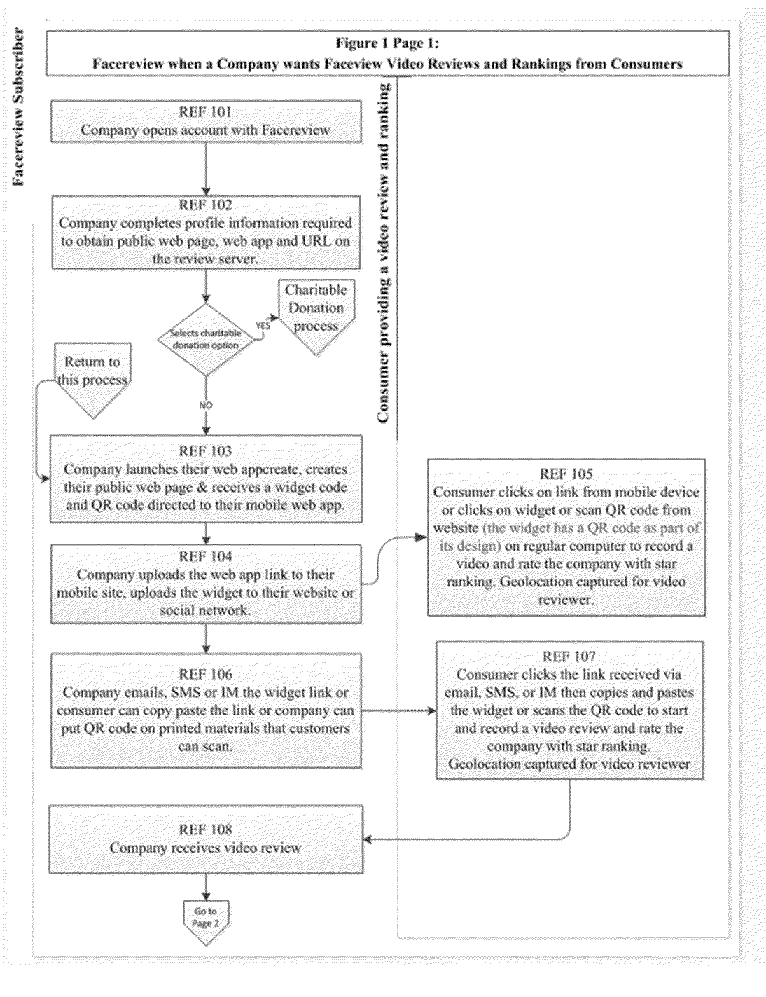

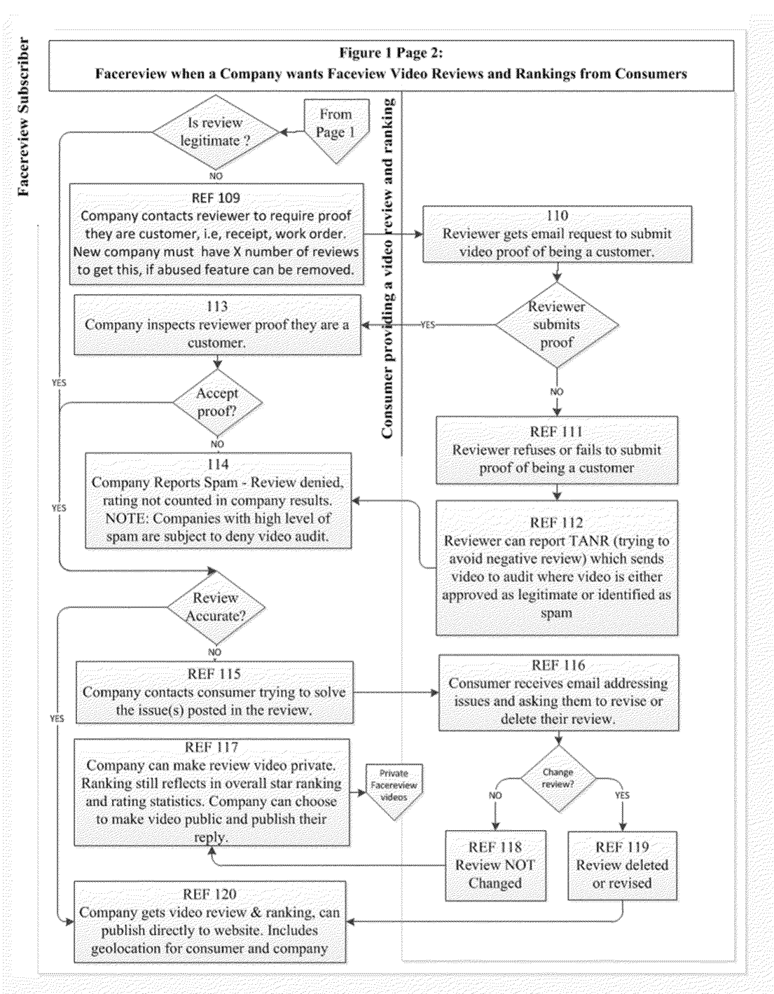

There is shown in FIG. 1 pages 1 and 2, a flowchart illustrating the process that may be followed by a company desiring to subscribe to Facereview for video review and star ranking from their consumers. The subscribing company may first open an account, at REF 101 and, in REF 102, complete company profile information, and obtain: a company public web page, (ii) a company web app, and (iii) an associated URL on the review web server.

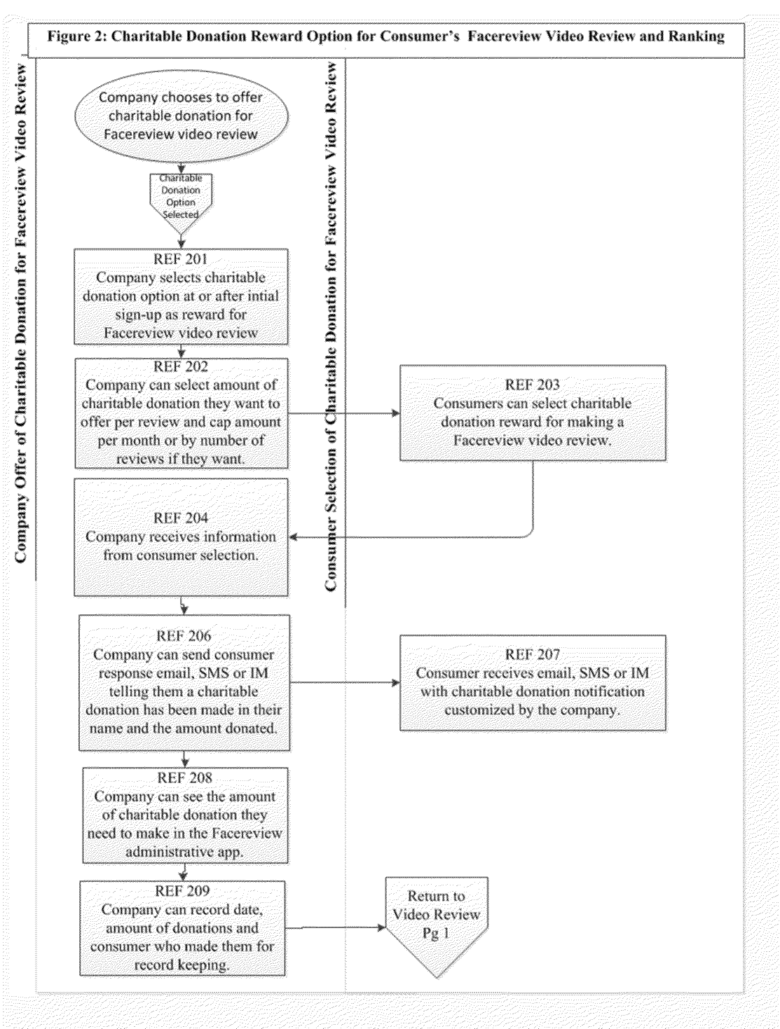

An option, linked from FIG. 1 below REF 102, allows the subscribing company to select whether or not a reward will be provided to a consumer. The process of setting up and managing the reward system, where the reward is provided in the form of a charitable donation, is illustrated in FIG. 2, and described in greater detail below.

There is shown in FIG. 1 a flowchart illustrating the process for a company subscribing to Facereview for video review and ranking from their consumers. At REF 103, the company launches their web, herein denoted as “appereate,” so as to create their public web page. The company receives a widget code with an embedded QR code and a separate QR code they may use on printed materials that is directed to their review web app.

In the flowchart of FIG. 1, the company next executed the step of REF 104 wherein the company may upload their review web app to their website or to their social networking site.

At REF 105, the consumer may click directly on the Facereview link or widget from the company's website, or scan the QR code to access the company's Facereview URL for the video review and star ranking tools. The consumer may then record his or her video review, and select the star ranking to rate the company's performance. When the consumer uploads the video review the geolocation of the consumer is captured and associated to the customer video review.

At REF 106, the company may send to the customer via email, via SMS, or via an IM, the appropriate review web app widget. Alternatively, the consumer can scan or copy the QR code on the company website or from the company's printed materials to provide the consumer with linked access to the company's Facereview URL.

At REF 107, the consumer can click the Facereview widget received in the email, SMS or IM message, that the company sent to them, where the received Facereview widget links to the company's Facereview video review URL. Once the customer is on the company's Facereview video review URL, the consumer can then record and upload his or her video review and select star ranking for the company's performance.

Alternately, the consumer can scan the QR code using a mobile device, or can copy the QR code and email it to a selected mobile device. Subsequently, when the QR code is scanned, Facereview may make a call to the consumer's mobile device camera. In response, the comsumer's mobile device can upload the video review to the company's Facereview video review URL and the consumer can select the star ranking for the company's video performance. When the consumer's review video is uploaded, the geolocation of the consumer is captured and associated with the review video.

It should be understood that the consumer requires access to the company video review URL through the Facereview widget or the QR code, or the consumer will not be enabled to upload a video to the company. If company selected a donation option, and the donation option is offered to the consumer, the consumer can also choose his preferred donation charity from those that the company offers.

At REF 108, shown in FIG. 1, the company receives the consumer's video review and determines if the review is legitimate or not. This step is a decision about whether the video review actually came from one of the company's customers, and whether or not the video review is spam.

At REF 109, the company contacts the video reviewer to request proof that the video reviewer is legitimate and is a company customer. Proof would consist of service details such as: (i) date and time of service, (ii) a receipt for services provided, or (iii) the name of the consumer if that is not the same as the person uploading the video review. This feature, which screens video reviews for spam, is not granted to newly-subscribing companies until the company has had a pre-specified threshold number of video reviews (i.e., ‘X’ reviews). If this feature is abused by the company, such as when the company attempts to screen out negative reviews by claiming that one or more of the negative reviews are spam, Facereview may respond by removing the ability of the company to screen out reviews.

In FIG. 1, REF 110 illustrates that the reviewer may be sent an email requesting the reviewer to submit proof of being a customer of the company. If the reviewer has proof of being a legitimate customer, the reviewer can submit such proof to the company via email.

The reviewer may refuse or fail to submit proof of being a customer of the company. If the reviewer has submitted proof, the company receives the proof from the reviewer, inspects the proof, and makes a decision whether or not to accept the proof.

Alternatively, in REF 111, the reviewer may refuse or fail to submit proof of being a customer of the company.

At REF 113, shown in FIG. 1, the company can determine that the proof the consumer submitted fraudulent or not acceptable or if the consumer did not submit proof by either refusing to submit proof or failing to submit the proof, the company can report the video review as spam and remove it from their review page. The Facereview system will know if the consumer submits any type of information as a proof or ignores the request for proof from the company. Ignoring a request for proof would result in the supposed consumer video review being identified as spam.

An exemplary embodiment, a company with a high level of reported spam may be subjected to an audit of the reported spam to determine if the company is reporting spam for the purpose of Trying to Avoid Negative Reviews (TANR). Audits may comprise: (i) reviewing all company video reviews marked as spam, (ii) reviewing proof of spam, as alleged by the company, and (iv) determining if the proof is legitimate. The action taken by Facereview may also include contacting the consumer to get their story. It should be understood that such audits are optional only, and may be performed at the discretion of the Facereview system.

At REF 112, shown in FIG. 1, the reviewer can report TANR (Trying to Avoid Negative Reviews) if the reviewer feels that the video company is alleging that the reviewer is not a customer in order to disallow the customer's video review. A report of TANR will initiate an audit by Facereview to determine if the video review in dispute is legitimate, or if the review is a spam review.

At REF 114, the video company has reported spam, and the submitted review is not added to the video review results for the company. For a company having a high level of reported spam, the Facereview system may subject such companies to a “deny video” audit.

At REF 115, shown in FIG. 1, the company has determined that the video review is legitimate and is not spam. The company then acts to determine if the review is accurate. If the company does not feel the review is accurate or if the review is negative and reveals problems, the company may contact the consumer in an effort to resolve issues revealed in the review and to ask the consumer to revise or delete the review.

Shown in FIG. 1, REF 116, the consumer receives the dialog from the company asking them to revise or delete their video review. The consumer makes a decision whether or not to change their review.

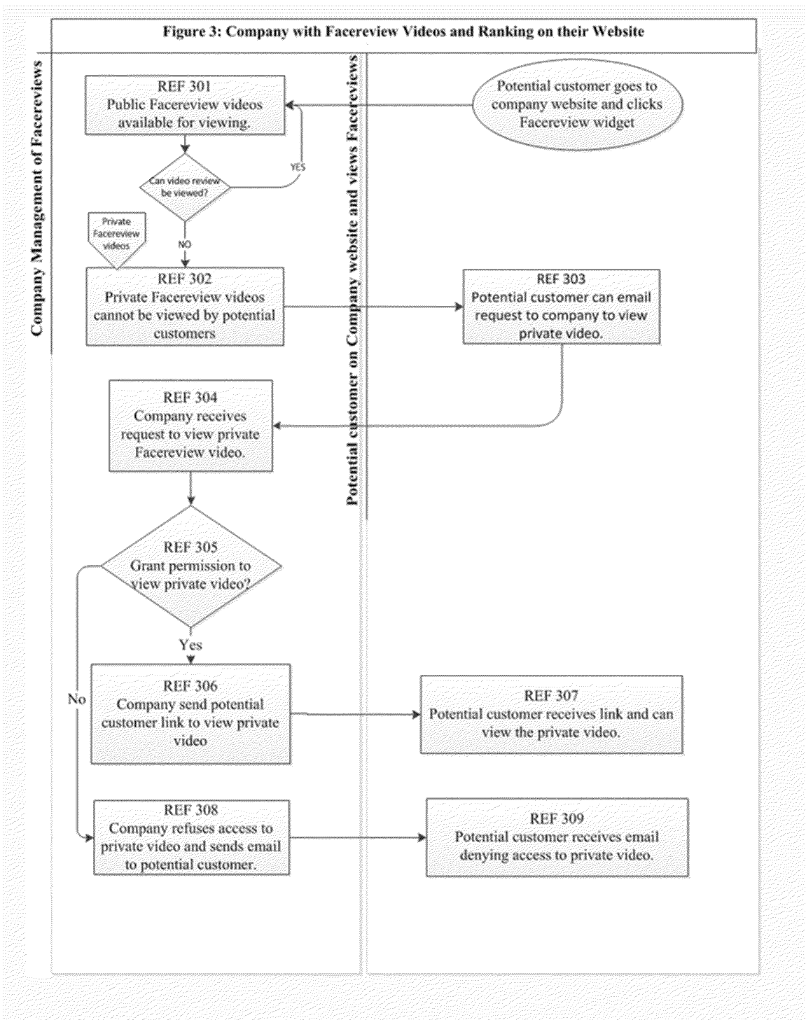

At REF 117, the company may choose to make a negative video review private. A private review means that the video review will not be readily available to potential customers. Potential customers may contact the company to request access to view the private video review which is described below, in FIG. 3.

In FIG. 1, REF 118, the consumer chooses not to change the review described in REF 115. The star ranking given by the reviewer will still be incorporated into the company's overall results and will be included in the review statistics. The company is notified that the customer review is not changed.

In REF 119, in FIG. 1, the consumer may choose to revise or delete their video review, which is then uploaded to the company. When the consumer chooses to revise their video review, the company receives the updated video review. If the consumer chooses to delete their video review, the company is informed of the deleted review.

In FIG. 1, REF 120, the review is presumed to be both legitimate and accurate. The company receives the video review and ranking and posts it to the company website including the geolocation for the consumer and for the company.

In FIG. 2, REF 201, the company selects an option to offer the consumer a reward, in the form of a charitable donation, as an incentive to provide a video review.

REF 202, in FIG. 2, illustrates that a company can choose an amount for charitable donation for each video review. The company can set a cap for charitable donation either by monetary amount or by number of video reviews for which a charitable donation may be made.

REF 203, in FIG. 2, illustrates that a consumer can select the option for the company to make a charitable donation as a reward for the consumer providing a video review.

REF 204, in FIG. 2, illustrates that the company receives notification that the consumer has selected the option of a charitable donation for giving the company a video review. Alternatively, the company may receive a notification that the consumer has declined to accept the option of a reward.

In FIG. 2, REF 206 illustrates that the company may send to the consumer a response email message, SMS or IM message telling the consumer that a charitable donation has been made, or will be made, to reward the consumer for the video review.

REF 207, in FIG. 2, illustrates that the consumer then receives a response message from the company notifying them of the charitable donation the company is making for their video review.

In FIG. 2, REF 208 illustrates that the company can see the number and amount of charitable donations they need to make in the Facereview administrative application.

REF 209, in FIG. 2, illustrates that the company can record the dates and the amount of the charitable donation they have made in the company's Facereview administrative application.

In FIG. 3, REF 301 Facereview videos are available on the company's website for potential customers to view at any time, with the exception of private review videos which cannot be immediately viewed.

FIG. 3, REF 302, illustrates that private review videos cannot be immediately viewed from the company's website by a potential customer.

REF 303, in FIG. 3, illustrates that potential customers can email the company for permission to access private review videos.

For example, as shown in REF 304, the company may receive a request from a potential customer to view a private video.

REF 305, in FIG. 3, illustrates that the company then makes a decision whether or not to allow a potential customer to view a private video.

In FIG. 3, REF 306, the company decides to grant a potential customer access to view a private review video.

REF 307, in FIG. 3, illustrates that a potential customer receives a link to view the private video which they may then use to access the review video.

In REF 308, FIG. 3, the company decides not to allow a potential customer access to view a private video and sends notification to the potential customer denying access to the review video.

In FIG. 3, REF 309, the potential customer receives notification from the company denying access to the private review video.

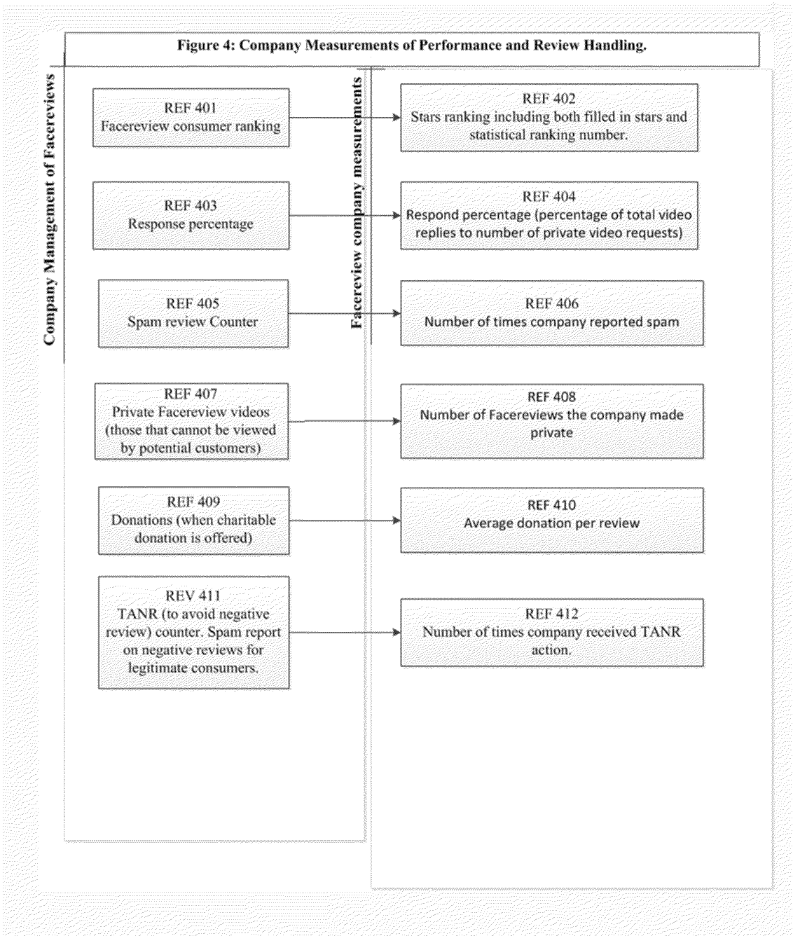

REF 401, in FIG. 4, illustrates the Facereview company ranking as a Facereview company measurement.

REF 402, in FIG. 4, illustrates that the Facereview company ranking is shown as a star ranking with filled in stars and a statistical ranking number.

REF 403, in FIG. 4, illustrates the company's response percentage as a Faceview company measurement.

REF 404, in FIG. 4, illustrates that the response percentage is expressed as the number of total video reviews compared to the number of private video requests.

REF 405, in FIG. 4, illustrates that a measure of the company's performance is a spam review counter.

REF 406, in FIG. 4, illustrates the spam review counter as the number of times the company has reported spam.

REF 407, in FIG. 4, illustrates that a measure of the company's performance is the number of private video reviews.

REF 408, in FIG. 4, illustrates that the private video reviews are an actual count of the number of private video reviews.

REF 409, in FIG. 4, illustrates that a measure of the company's performance is the charitable donations the company has made. This is reported only when the company has selected charitable donations as a means to reward consumers for giving them a video review.

REF 410, in FIG. 4, illustrates that the Donation measurement is expressed as an average donation per video review.

REF 411, in FIG. 4, illustrates the Trying to Avoid Negative Reviews (TANR) counter as a measure of the company's performance.

REF 412, in FIG. 4, illustrates that the TANR counter is comprised of the number of times the company received TANR action, which is a spam report on the legitimate reviews from actual customers.

It is to be understood that the description herein is only exemplary of the invention, and is intended to provide an overview for the understanding of the nature and character of the disclosed video review and ranking process. The accompanying flow charts are included to provide a further understanding of various features and embodiments of the method and devices of the invention which, together with their description serve to explain the principles and operation of the invention.

What is claimed is:

1. A method of managing video reviews and rankings, to a company providing video products, from a consumer utilizing company electronic media files delivered online, said method comprising the steps of:
verifying that the consumer is a customer of the company;
if the consumer is verified, company obtains video review and ranking;
company determines whether or not to offer a charitable donation in return for said video review and ranking; and
if charitable donation has been made, notifying the verified consumer of the donation.
